(19) United States
(12) Patent Application Publication
(10) Pub. No.: US 2015/0100576 A1
(43) Pub. Date: Apr. 9, 2015

(54) Default Network

(71) Applicant: Foxwordy, Inc., San Carlos, CA (US)

(72) Inventors: Monica Zent, Sunnyvale, CA (US); Robert Schmitt, Santa Barbara, CA (US)

(73) Assignee: Foxwordy, Inc., San Carlos, CA (US)

(21) Appl. No.: 14/188,566

(22) Filed: Feb. 24, 2014

Related U.S. Application Data
(60) Provisional application No. 61/889,006, filed on Oct. 9, 2013.

(51) Int. Cl. G06F 17/30; H04L 29/08

(52) U.S. Cl. CPC G06F 17/30598; H04L 67/306
USPC 707/737

(57) ABSTRACT

A system and a method are disclosed for creating a default network from a social network computing system. The default network contains user profiles of users who have one or more attributes in common. The attributes on which a default network is based may be chosen for users or may be chosen by users according to interest. A default network is used to suggest that a user having a user profile in the default network establish a connection with another user whose user profile is in the same default network. Users with user profiles in the same default network may participate in interactions such as making referrals, sharing content, and posing questions. User profiles in a default network may be filtered for display according to characteristics of user profiles.

### CROSS REFERENCE TO RELATED APPLICATIONS

This application claims the benefit of U.S. Provisional Application No. 61/889,006, filed Oct. 9, 2013, which is incorporated by reference in its entirety.

### BACKGROUND

1. Field of Art

The disclosure generally relates to the field of social networking, and more particularly, to connecting users of a social network.

2. Description of the Related Art

Users of a social network generally seek both to interact with contacts they have already met and to meet new contacts. Though some social networks allow a user to manually initiate connections to other users, the number of potential connections is potentially overwhelming. Users may be disinclined to search for users whom they have not already met. Although some social networks present options for filtering of potential contacts, users may not use these options due to lack of insight about which filters may yield worthwhile contacts. Users of social networks can also face problems arising from overly extensive social networks. Once a user's social network has too many users with dissimilar interests, the social network loses its value for disseminating relevant content. Although some social networks allow for manual categorization of contacts, the network's sheer number of contacts may dissuade users from thoroughly categorizing their contacts.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of components of an example machine able to read instructions from a machine-readable medium and execute them in a processor (or controller).

FIG. 2 illustrates an architectural configuration used to implement one example embodiment of a default network computing system.

FIG. 3 illustrates a block diagram of a network server used to implement the default network computing system in one embodiment.

FIG. 4 illustrates an entry in a user profile store in one embodiment.

FIG. 5 illustrates an entry in a connection store in one embodiment.

FIG. 6 illustrates an entry in a connection request store in one embodiment.

FIG. 7 illustrates a flow chart of an example process to handle connection requests in an embodiment of a connection engine.

FIG. 8 illustrates a flow chart of an example process to group users into default networks in an embodiment of a default network engine.

FIG. 9 illustrates a flow chart of an example process to filter users for display in an embodiment of a user interface engine.

FIG. 10 illustrates an example user interface for creating and handling connection requests in one embodiment.

FIG. 11 illustrates an example user interface to view filtered users in one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method, and computer readable storage medium is disclosed for creating a default network from user profiles in a default network computing system. User profiles are created by users of the default network computing system. In response to a request from a viewing user, a default network is created for that user's user profile. The default network contains user profiles having one or more attributes in common with the requesting user's user profile. The default network computing system includes one or more client devices connected to a network server through a network. The client devices are used by users to view and interact with the default network computing system. The network server stores the user profiles and other data relevant to the default network computing system and prepares the data for display to provide to a user of a client device.

The default network computing system connects the one or more client devices with the network server. The network server stores data relating to user profiles, user profile pages, connections between users, pending connections requests between users, default networks associated with users, and previous interactions between one or more users on the default network. The network server additionally processes data to create and update connections and default networks. The network server also filters and organizes user profiles for display to a user. User profile data is stored in user profile entries, and connections between users are stored as connection entries and connection request entries. Further entries may record user interactions and membership in a default network.

A disclosed embodiment to create connections within the default network includes configuring a system to receive connections, checking a user's receptiveness to connections, creating a connection request, and informing the connection request's recipient. If the connection request recipient accepts a connection, then a connection entry is created and the connection request entry is updated. After a connection request is accepted, the requesting user is notified. To create or update a shared network, a user profile is selected, and one or more attributes of the received user profile are retrieved. The user profile is added to a default network containing user profiles having one or more attributes in common with the selected user profile. User profiles in the default network are displayed for a viewing user. To display user profiles in a default network or other group of user profiles, filtering criteria may be received from viewing a user to filter user profiles from a group of user profiles. User profiles that pass the filter may be selected for a subset of displayed user profiles. User interfaces may display suggested user profiles for establishing connections. User interfaces may also display directories of user profiles in the default network computing system.

### Computing Machine Architecture

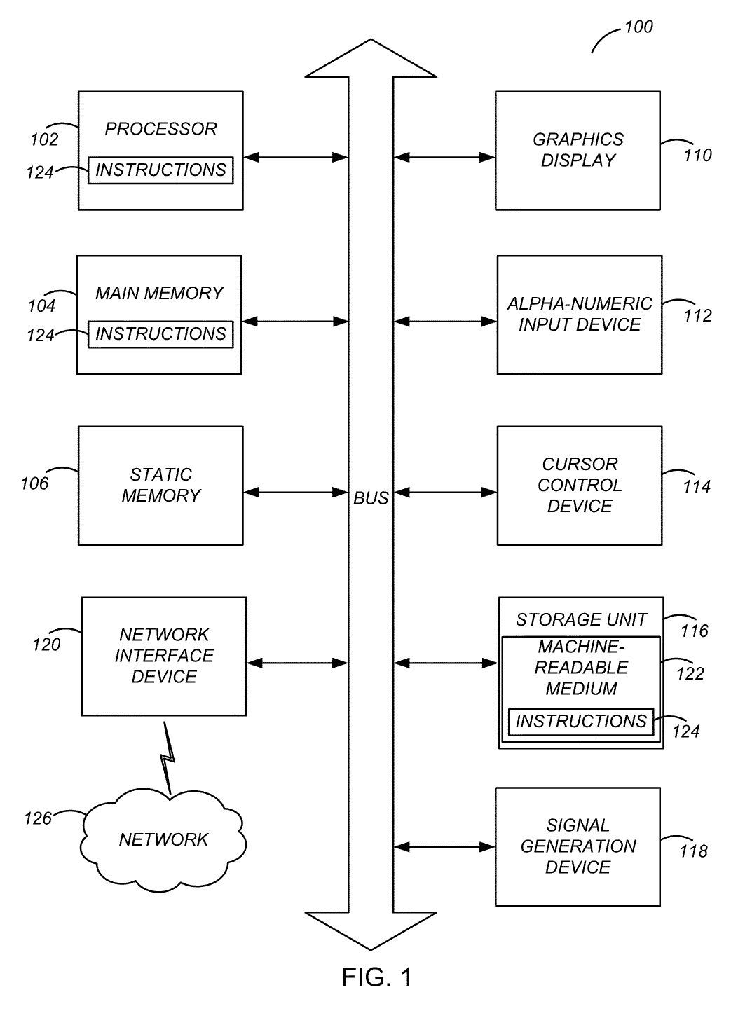

FIG. 1 is a block diagram illustrating components of an example machine able to read instructions from a machine-readable medium and execute them in a processor (or controller). Specifically, FIG. 1 shows a diagrammatic representation of a machine in the example form of a computer system 100 within which instructions 124 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 124 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 100 includes a processor 102 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 104, and a static memory 106, which are configured to communicate with each other via a bus 108. The computer system 100 may further include graphics display unit 110 (e.g., a plasma display panel (PDP), a liquid crystal display (LCD), a projector, or a cathode ray tube (CRT)). The computer system 100 may also include alphanumeric input device 112 (e.g., a keyboard), a cursor control device 114 (e.g., a mouse, a trackball, a joystick, a motion sensor, or other pointing instrument), a storage unit 116, a signal generation device 118 (e.g., a speaker), and a network interface device 120, which also are configured to communicate via the bus 108.

The storage unit 116 includes a machine-readable medium 122 on which is stored instructions 124 (e.g., software) embodying any one or more of the methodologies or functions described herein. The instructions 124 (e.g., software) may also reside, completely or at least partially, within the main memory 104 or within the processor 102 (e.g., within a processor's cache memory) during execution thereof by the computer system 100, the main memory 104 and the processor 102 also constituting machine-readable media. The instructions 124 (e.g., software) may be transmitted or received over a network 126 (e.g., WiFi, 3G, 4G, Ethernet, digital subscriber line (DSL), fiber optic network) via the network interface device 120.

While machine-readable medium 122 is shown in an example embodiment to be a single medium, the term “machine-readable medium” should be taken to include a single medium or multiple media (e.g., a centralized or distributed database, or associated caches and servers) able to store instructions (e.g., instructions 124). The term “machine-readable medium” shall also be taken to include any medium that is capable of storing instructions (e.g., instructions 124) for execution by the machine and that cause the machine to perform any one or more of the methodologies disclosed herein. The term “machine-readable medium” includes, but not be limited to, data repositories in the form of solid-state memories, optical media, and magnetic media.

### Example Architectural Configuration

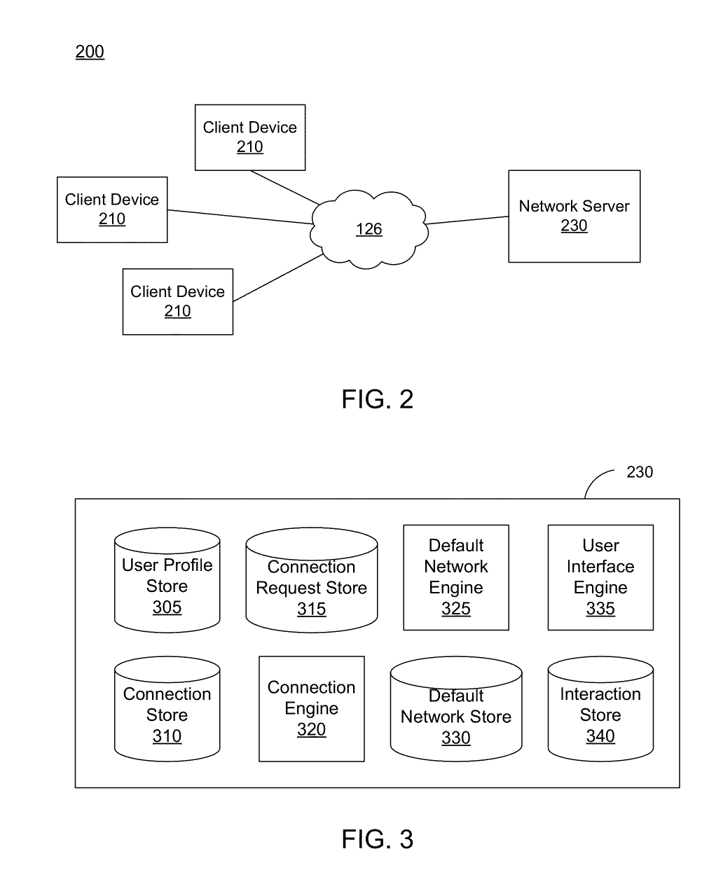

Referring now to FIG. 2, illustrated is a block diagram of a default network computing system 200 in an example embodiment. The default network computing system 200 includes one or more client device 210 (e.g., a personal computer, a tablet, a smartphone, a cellular phone, a terminal, a smart television, a personal digital assistant (PDA), a smart watch, a wearable computer), a network 126, and a network server 230. A computer system 100 may be used in some embodiments of the client device 210 and/or network server 230. The one or more client devices 210 are coupled to the network 126, which is in turn coupled to the network server 230. In an alternate embodiment, additional networks 126, client devices 210, and/or network servers 230 may be present. For example, an additional network server 230 may act as a proxy server between the one or more client devices 210 and another network server 230.

The one or more client devices 210 may be used by users to view, upload, and submit, and interact with content in the default network. For example, a user may provide a numerical rating of content uploaded by another user. Users of the one or more client devices 210 may create user profiles and may connect their user profile on the default network to other user profiles on the default network. Users of the one or more client devices 210 may declare or modify preferences governing their user profile and/or content they upload. For example, a user may limit who may view content that the user has uploaded. In an example embodiment, HyperText Markup Language (HTML) code is used to display content on a client device 210. Alternate embodiments may use Extensible Markup Language (XML) or JavaScript Object Notation (JSON). A client device 210 may be associated with a single user profile, or the client device 210 may be associated with multiple user profiles. In an embodiment, a user may access their user profile through multiple client devices 210.

In one embodiment, the network server 230 stores data about the default network including user profiles, content, and connections between users. The network server 230 may retrieve and/or process data as requested by users of client devices 210. In an example embodiment, HyperText Transfer Protocol (HTTP) may be used to exchange or transfer data between a network server 230 and a client device 210 using HTTP methods including GET, POST, PUT, and DELETE. In an alternate embodiment, some or all of the processing and/or storing functions of the network server 230 may be performed by one or more client devices 210 alone or in combination with a network server 230. In an alternate embodiment, a single device may implement components of a client device 210 and a network server 230.

Referring now to FIG. 3, illustrated is a block diagram of a network server 230 used to implement the default network in one embodiment. The network server 230 contains a user profile store 305, a connection store 310, a connection request store 315, a connection engine 320, a default network engine 325, a user interface engine 330, a default network store 335, and an interaction store 340. The user profile store 305 contains information that a user has provided (e.g., a user profile created by a user). The connection store 310 stores, using connection entries, one or more connections made between users using their user profiles. In an embodiment, the connections are stored as connection entries between a particular user profile and another user profile, but alternate embodiments may include connection entries associating three or more users. The connection request store 315 stores pending connection requests as connection request entries. When a first user requests a connection with a second user, then there is a pending connection until the second user chooses to accept or ignore the requested connection. In an alternate embodiment, the second user may deny, delete, or otherwise rebuff the connection request from the first user.

The connection engine 320, which may be configured with elements similar to the computer system 100, implements a process for creating connection entries and processing connection request entries. The connection engine 320 retrieves and/or modifies data from the user profile store 305, the connection store 310, and/or the connection request store 315. The default network engine 325, which may be configured with elements similar to the computer system 100, uses information from the user profile store 305 to create one or more default networks for a user profile in the default network computing system 200. In one embodiment, the default network engine 325 may store, read, and/or modify data in the default network store 335. In an alternate embodiment, the default network engine 325 may use information from the connection store 310, the connection request store 315, and/or interaction store 340 to create one or more default networks. In an alternate embodiment, the default network engine 325 may receive inputs through an Application Programming Interface (API) and return information about a constructed default network, including user profiles in the default network and attributes on which the default network is based, through the API.

The default network store 330 stores data relating to a default network. In an embodiment, a default network is created for a particular user profile based on one or more attributes. An example entry in this default network store 330 may include a unique user identification (ID) for the particular user profile, user IDs of user profiles in the default network, and common attributes of those user profiles in the default network. In an alternate embodiment, default networks are created based on or more attributes but not for a particular user profile. In the alternate embodiment, an example entry in the default network store 330 may include a unique default network ID, the attributes used to create the default network, and the user IDs of user profiles in the default network. In the alternate embodiment, a user profile entry 400 in the user profile store 305 may include a field containing default network IDs corresponding to the default networks containing the user profile.

The user interface engine 335, which may be configured with elements similar to the computer system 100, creates interfaces to provide for display on a client device 210. Example interfaces may be structured to display a user profile page, connections of a user profile, pending connections, potential connections, one or more connections in a default network, content submitted by a user, interactions between one user profile and another user profile, and/or aggregations of user interactions. Example interfaces may be structured to display data passively and/or accept input from the user of a client device 210. The user interface engine 335 may retrieve, store, and/or modify data from the user profile store 305, the connection store 310, the connection request store 315, the default network store 330, and/or the interaction store 340.

The interaction store 340 contains entries recording interactions between users. For example, the interaction store 340 may record when a user chooses to follow another user's user profile, to state interest in another's user profile, to state another's user profile as a favorite, to share content with another user, to comment on content, to rate content, up vote or like content, to make or fulfill a request, to ask or answer a question, to request or make a referral, to search for content, to search for a user profile, or to view content. Entries in the interaction store 340 may include fields identifying the interaction type, an interaction identification (ID), a user ID of the user who initiated the interaction, a user ID of a user profile at which an interaction is directed, a time the interaction occurred, a time the interaction was updated, an interaction ID corresponding to another interaction responsive to the interaction, a message included in the interaction, and other fields relevant to the particular interaction.

### User and Connection Data

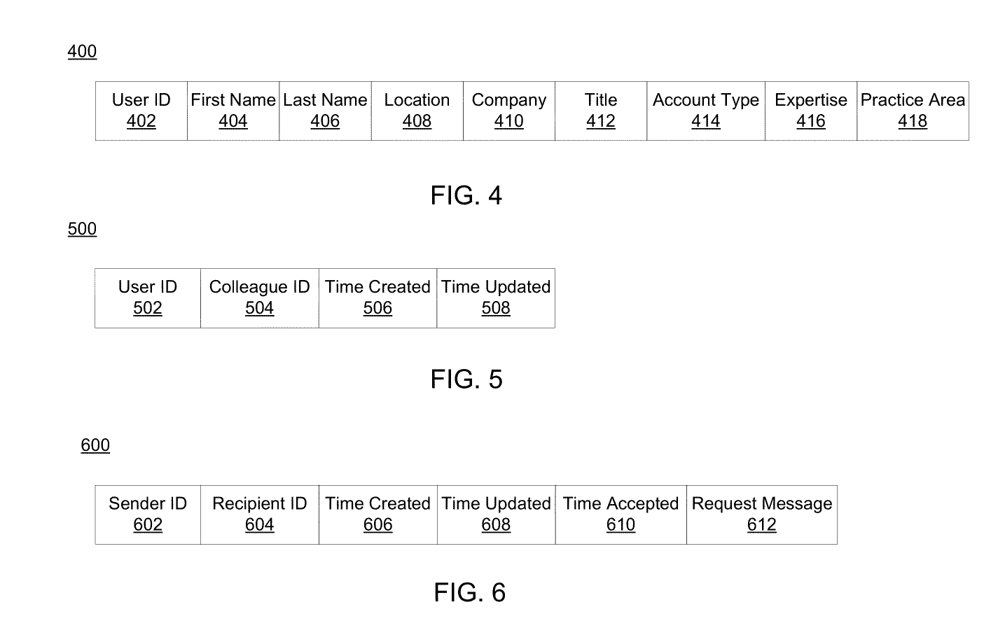

Referring now to FIGS. 4 through 6, illustrated are entries to store user and connection data, in one embodiment. In one embodiment, data stores (e.g., 305, 310, 315, 335, 340) are implemented in a Relational Database Management System (RDBMS) implemented by programming languages such as Structured Query Language (SQL), PostgreSQL, MySQL, SQL Server, or Oracle. A user profile entry 400 contains, for example, all or a subset of a user identification (ID) field 402, a first name field 404, a last name field 406, a location field 408, a company field 410, a title field 412, an account type field 414, an expertise field 416, and a practice area field 418. The user profile entry 400 implements one embodiment of the user profile store 305. The user ID field 402 is a unique identifier for a particular user profile and may be used to refer to the user profile whenever the user profile is referenced in other data entries. The first name field 404 and the last name field 406 are provided by the user upon profile creation. In one embodiment, the first name field 404 and/or last name field 406 may be omitted for purposes of anonymity. The location field 408 may comprise one or more of cities, states, provinces, territories, countries, regions, postal codes, telephone area codes, countries, addresses, geospatial coordinates, or any combination thereof. The company field 410 indicates where a user works. The title field 412 indicates a user's job title.

The account type field 414 indicates what type of account a user has with the default network computing system. For example, a user may have a free membership, or a paid membership. In an embodiment, there may be a plurality of paid membership types having access to varying features of the default network. Example account types may include “Standard” for basic access, “Premium” for enhanced access, and “Enterprise” for companies or other groups. The expertise field 416 indicates specialized knowledge that a user may have (e.g., trademarks, Sarbanes-Oxley compliance, anesthetic hypersensitivity screening, heat exchanger design, baroque chamber music). Practice area may indicate more broadly what a user knows (e.g., intellectual property law, public corporation accounting, anesthesia, process engineering, historical Western music). In an alternate embodiment, a field may specify a plurality of data such as first names, last names, locations, companies, titles, areas of expertise, and/or practice areas. An alternate embodiment may contain fewer data fields and/or additional data fields such as time created, time updated, email address, account password, account payment information, phone number, professional certifications, publications, previous work history, prior projects, educational data, user preferences and settings, and other personal data a user chooses to upload to the user's profile. For example, a user may upload an image as a user profile picture, and the corresponding image file (or a reference to said file) may be included in the user profile entry 400.

A connection entry 500 contains a user ID field 502, a colleague ID field 504, a time created field 506, and a time updated field 508. The connection entry 500 implements one embodiment of the connection store 310. The user identification (ID) field 502 is a unique identifier to reference a first user profile and to link together separate data entries concerning a user. In one embodiment, the user ID 502 for the first user profile is identical to the user ID field 402 in the first user's user profile entry 400. The colleague identification (ID) field 504 is a unique identifier to reference a second user profile. In one embodiment, the colleague ID field 504 for the second user is identical to the user ID field 402 in the second user's user profile entry 400. In an embodiment, the user ID 502 corresponds to a user who requested a connection and the colleague ID 504 corresponds to a user who accepted the requested connection. The time created field 506 is the time at which the connection entry 500 was created. In an embodiment, the time created field 506 is when a connection request was accepted. The time updated field 508 is the most recent time at which part of the connection entry 500 was updated. The time updated may indicate when a user ID field 502 or colleague ID 504 field was modified, or may refer to a time at which the connection entry 500 was last verified.

A connection request entry 600 contains a sender ID field 602, a recipient ID field 604, a time created field 606, a time updated field 608, a time accepted field 610, and a request message field 612. The connection request entry 600 implements one embodiment of the connection store 310. The user identification (ID) field 602 is a unique identifier referencing the user profile that sent the connection request. In one embodiment, the sender ID field 602 for a first user is identical to the user ID field 402 in the first user's user profile entry 400. The recipient identification (ID) field 604 is a unique identifier to reference a user profile to which a connection request was sent. In one embodiment, the recipient ID field 604 for a second user profile is identical to the user ID field 402 in the second user's user profile entry 400.

The time created field 606 is the time at which the connection request entry 600 was created. In an embodiment, the time created field 606 is when a connection request was sent. The time updated field 608 is the most recent time at which part of the connection request entry 600 was updated. The time updated may indicate when a sender ID field 602 or recipient ID field 604 was modified, or may refer to a time at which the connection request entry 600 was last verified. The time accepted field 610 is the time when a connection request was accepted. If the connection request corresponding to the connection request entry 600 is pending, then the time accepted field 610 may be undefined or empty. In an alternate embodiment, the connection request entry may have data fields for time responded and/or response type in addition to and/or in place of the time accepted field 610. Data fields corresponding to events like the time created 506, 606, the time updated 508, 608 and the time accepted 610 may contain both a date and a time. In one embodiment, these data fields may contain both a universal time and a local time (i.e., the local time for the user performing the action). The request message field 612 is a text input by the user who sent the connection request addressed to the recipient of the connection request. In one embodiment, the request message field 612 may be undefined or empty because a user did not enter a request message.

### Creating Connections

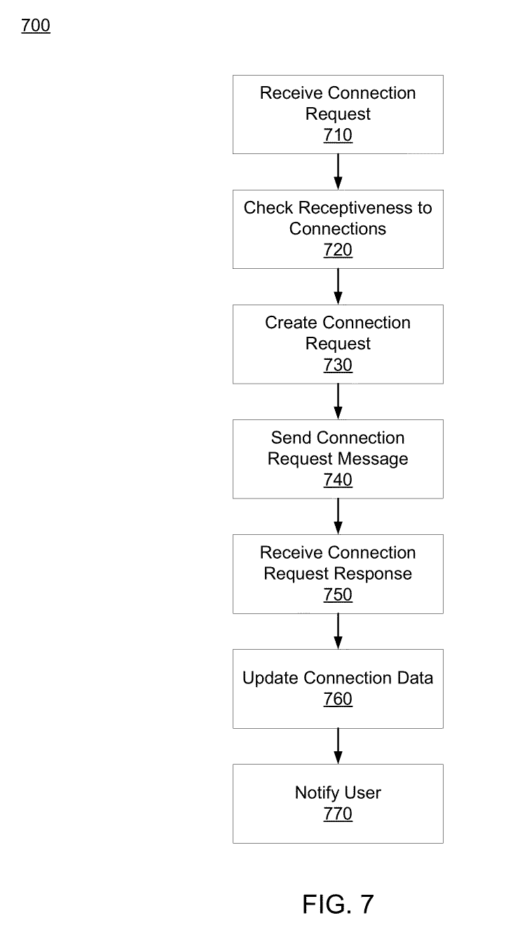

Referring now to FIG. 7, illustrated is a flowchart of an example process to handle connection requests in an embodiment of the connection engine 320. The connection handling process 700 receives 710 a connection request, checks 720 a user's receptiveness to connections, creates 730 a connection request, sends 740 a connection request message, receives 750 a connection request response, updates 760 connection data, and notifies 770 the user. A sender user creates a connection request using a user interface to select a connection with a recipient user. The connection request is received 710 by the default network server 230 through the user interface engine 335 or through an API. The connection request is checked 720 to determine if the connection request recipient is receptive to connections, which may be done according to preferences found in the user profile store 205 or, in an alternate embodiment, in a dedicated store for user privacy preferences. In an embodiment, the connection request is checked 720 to prevent users having different account type field 414 values from creating a connection. A connection request is created 730 by, in an embodiment, creating a connection request 600 entry in the connection request store 315.

A connection request is sent 740 to the recipient of the connection request. The connection request may be delivered by a message through the default network computing system, an email message, a text message to a phone with Short Message Service (SMS) or Multimedia Messaging Service (MMS), or a push notification to a smart phone, for example. Once the connection request recipient has chosen to accept or ignore a connection request, a connection request response 750 is received. How connection data is updated 760 depends on which response is received 750. If the connection request was accepted, then a connection entry 500 is created and the time accepted field 610 is updated in the connection request entry 600. If the connection request was ignored, then no connection entry 500 is created. In an embodiment, the connection request entry 600 is removed when an ignore connection request response is received 750. In an alternate embodiment, the ignore connection response is stored and used to prevent the sending user from further requesting a connection from the recipient user. The process for creating connections then notifies 770 the connection request sender of whether the connection request was accepted or denied. In an alternate embodiment, the sender is notified when a connection is accepted but not when a connection request is denied or ignored.

### Creating a Default Network

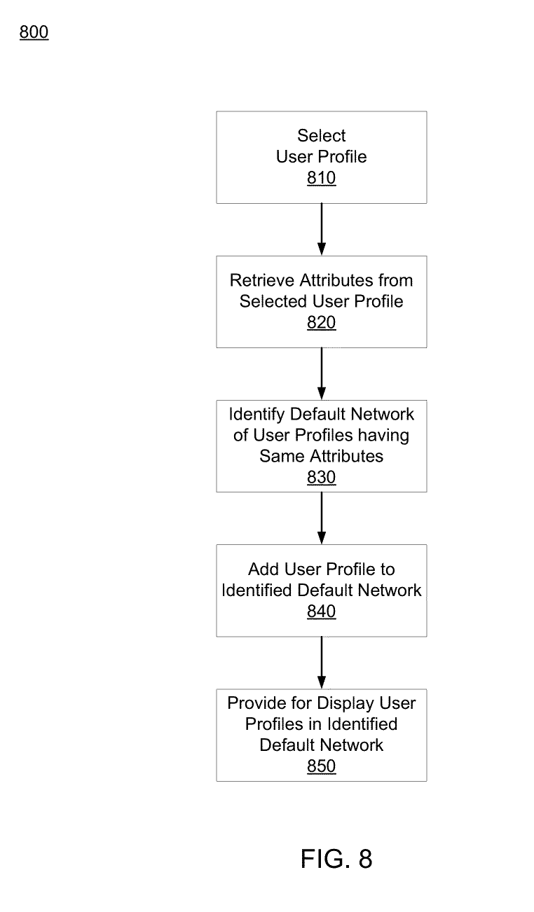

Referring now to FIG. 8, illustrated is an example process to create a default network. The default network creation process 800 selects 810 a user profile, retrieves 820 attributes from the selected user profile, identifies 830 a relevant default network, adds 840 the user profile to the identified default network, and provides 850 for display the default network. A user profile may be selected 810 for placement in a default network when a viewing user requests to see the default network containing the viewing user's user profile. In alternate embodiments, user profiles may be selected 810 when the user profile is created in the default networking environment 200, when a user requests placement of the user's user profile into a default network, when the attributes in a user profile are modified and/or added, or when a periodic routine chooses one or more unaffiliated user profiles for inclusion in a default network. In an embodiment, the default network computing system may select 810 user profiles that are not colleagues (i.e., user profiles having the same company field 410) with the viewing user. In an alternate embodiment, user profiles are selected regardless of employer. In an embodiment, a user profile may be part of one default network. In an alternate embodiment, user profiles may be part of more than one default network.

One or more user attributes are retrieved 820 from the selected user profile. In one embodiment, attributes retrieved may include attributes provided by the user and stored in the user profile store 305. In an alternate embodiment, attributes may be inferred from the user interaction store 340. Examples of attributes may be retrieved 820 from the location field 408, company field 410, title field 412, account type field 414, expertise field 416, practice area field 418, or any combination thereof. In an alternate embodiment, user attributes retrieved 820 may also include professional certifications, education, work history, demographic information, or any combination thereof. In one embodiment, attributes are retrieved according to defaults stored in the default network computing system. For example, default attributes may include account type and practice area. In an alternate embodiment, a user selects attributes to retrieve 820 as part of an input requesting that the user's user profile be placed in a default network. For example, if a user wants to connect with local practitioners in the same field, the user would select attributes like location (e.g., San Francisco) and a practice area (e.g., medical malpractice) when placing their user profile in a default network. In the example, the user's user profile would be placed in a default network with other user profiles having the same city (e.g., San Francisco) and practice area (e.g., medical malpractice). In an alternate embodiment, a user profile may be added to a default network using either attributes chosen by default or attributes selected by the user owning the user profile.

After retrieving 820 attributes, a relevant default network is identified 830. In an embodiment, default networks are defined by one or more attributes that the user profiles in the default network have in common. Consequently, the attributes retrieved 820 from the selected user lead to identification of a default network that contains users also having the retrieved attributes. For example, if the attributes retrieved are location and practice area, then the default network is composed of user profiles having the same values in the location field 408 (e.g., San Francisco) and practice area field 418 (e.g., medical malpractice law). In an alternate embodiment, user profiles in a default network share a minimum number of attributes out of a total number of retrieved attributes. For example, if location, account type, and practice area are retrieved 820, then an identified default network may contain user profiles having two or more of the retrieved attributes in common with the selected user profile. In an alternate embodiment, a default network may be identified 830 based on user profiles having one or more mandatory attributes in common in addition to having a minimum of one or more other attributes in common.

After identifying 830 a relevant default network in which to place the user profile that was selected 810, the user profile is added 840 to the identified default network. In an embodiment, the selecting 810, retrieving 820, identifying 830, and adding 840 may be repeated to add multiple user profiles to the default network. User profiles in a default network may be provided 850 for display, and/or stored temporarily. A record of user profiles in a default network may be stored in the default network store 330.

After adding 840 a user to a default network, user profiles in the default network are provided 850 for display (e.g., on a client device 210). Other user profiles in the same default network as a viewing user's user profile be displayed as part of an interface to recommend establishing connections, or may be displayed as a sortable list based on one or more characteristics of the user profiles. Characteristics used for sorting may include any of the fields 404-418 in a user profile entry 400, time elapsed since last interaction with a user profile, time elapsed since establishing a connection with a user profile, number of mutual connection with a particular user profile, and any combination thereof. User profiles in a default network may be visible to viewing users having a user profile in the same default network. In an alternate embodiment, another user may view a listing of user profiles in a default network containing another user's user profile.

### Filtering Users for Display

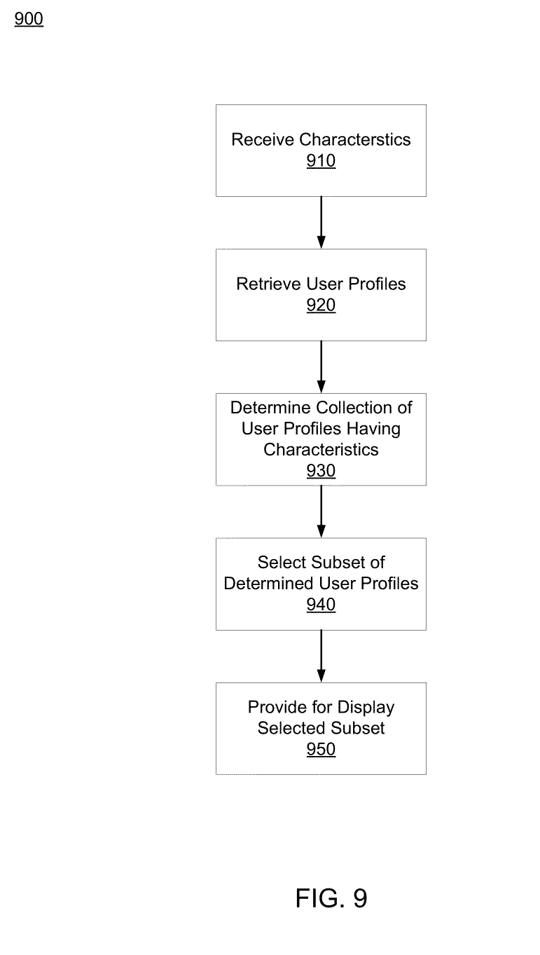

Referring now to FIG. 9, illustrated is an example process to filter users for display in an embodiment of a user interface engine 335. The user filtering process 900 receives 910 one or more criteria, retrieves 920 one or more user profiles, determines 930 a collection of user profiles, selects 940 a user profile subset, and provides the subset 950 for display. The one or more criteria received 910 may be chosen by a viewing user or may be chosen according to defaults chosen by administrators of the default network computing system. The one or more criteria received may include any of the fields 404-418 in a user profile entry 400, time elapsed since last interaction with the viewing user's user profile, time elapsed since establishing a connection with the viewing user, number of mutual connection with the viewing user, and any combination thereof.

User profiles are retrieved 920. In one embodiment, the user profiles retrieved 920 are the user profiles in the same default network as the viewing user's user profile. In an alternate embodiment in which user profiles may be in multiple default networks, a viewing user may choose one or more default networks from which user profiles are to be filtered. From the user profiles that are retrieved 920, a collection of user profiles is determined 930. Each user profile in the collection of user profiles contains the received criteria. In an alternate embodiment, user profiles in the determined collection have more than a minimum number of the one or more received criteria.

From the user profiles in the determined collection, a subset of user profiles is selected 940. The user profile subset selected 940 may include as many as all user profiles in the determined collection, or may include one or more user profiles selected 940 at random from the determined collection of user profiles. The number of user profiles selected 940 for the subset may be limited. For example, a limited number of user profiles may be selected 940 based on the size of a display space on the client device 210. In an alternate embodiment, one or more user attributes and/or characteristics may be used to select 940 a user profile subset. For example, user profiles may be selected 940 on proximity to the location in the user profile of a viewing user. As another example, user profiles may be selected 940 based on an alphabetic ordering of last names. As another example, user profiles of users who have requested a connection with the requesting user may be chosen 940 over user profiles of users who have not requested a connection with the viewing user. After a user profile subset is selected 940, the user profiles in the subset are provided 950 for display. In one example, user profiles may be provided 950 for display on client device 210 as part of a filtered listing based on criteria chosen by a user and received 910 by the user interface engine 335.

### User Interface

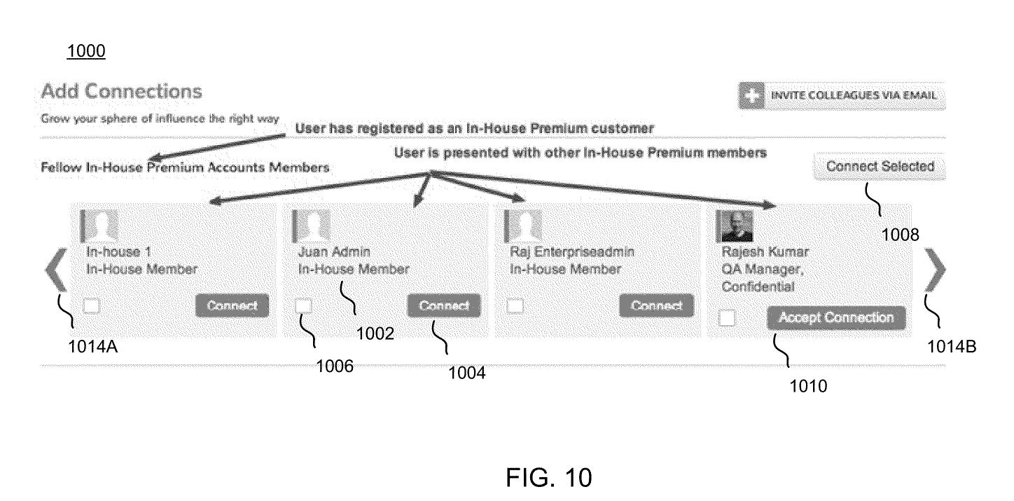

Referring to FIG. 10, illustrated is an example user interface for creating and handling connection requests in one embodiment of the disclosed configuration. The add connections interface 1000 includes a user identifier 1002, a request connection button 1004, a user select button 1006, a connect selected button 1008, an accept connection button 1010, and user scrolling buttons 1014. The add connections interface 1000 may present one or more user profiles of users with whom a viewing user is not connected, one or more user profiles of users requesting a connection with the visiting user, or a combination thereof. The user profiles may be chosen from a default network as created by the default network creation process 800.

User profiles that are displayed in the add connections interface 1000 are identified by a user identifier 1002. For example, a user identifier may include user name, title, and user profile picture. If a user profile picture is unavailable, a default picture may be used. In an alternate embodiment, a user's name or title may be made anonymous for privacy. In an alternate embodiment, a combination of any of the factors in a user profile entry 400 may be listed (e.g., company or location). The request connection button 1004 may be selected by a user to request a connection with the corresponding user through the connection handling process 700. The user select button 1006 may be used to select one or more users. After a user has selected one or more user profiles using the corresponding user select buttons 1006, the user may select the connect selected button 1008 to initiate connection requests with the selected user profiles through the connection handling process 700. When a user is sent 740 a connection request, the connection request may be displayed in the add connections interface 1000. When a user has requested a connection, an accept connection button 1010 may appear in place of a request connection button 1004. Selecting the accept connection button 1010 may create a connection entry 500 through the connection handling process 700. In an alternate embodiment, a button allowing a user to ignore a connection request may also be included with a user who has requested a connection.

In an embodiment, one or more user scrolling buttons 1014 enable a user to view additional user profiles besides those currently displayed. For example, selecting the left user scrolling button 1014A may shift the displayed user profiles to the right. The right-most user profile may be hidden and a new user profile may be displayed on the left. For example, selection of the right user scrolling button 1014B may shift displayed user profiles back to the left. A user profile that has become hidden due to the use of the left user scrolling button 1014A may reappear on the right side, and a user profile that has appeared on the left may become hidden. In one embodiment, a user may view any user profile in the user's default network through use of a user scrolling button 1014. In an alternate embodiment, a user may view a limited subset of user profiles as chosen in the user filtering process 900.

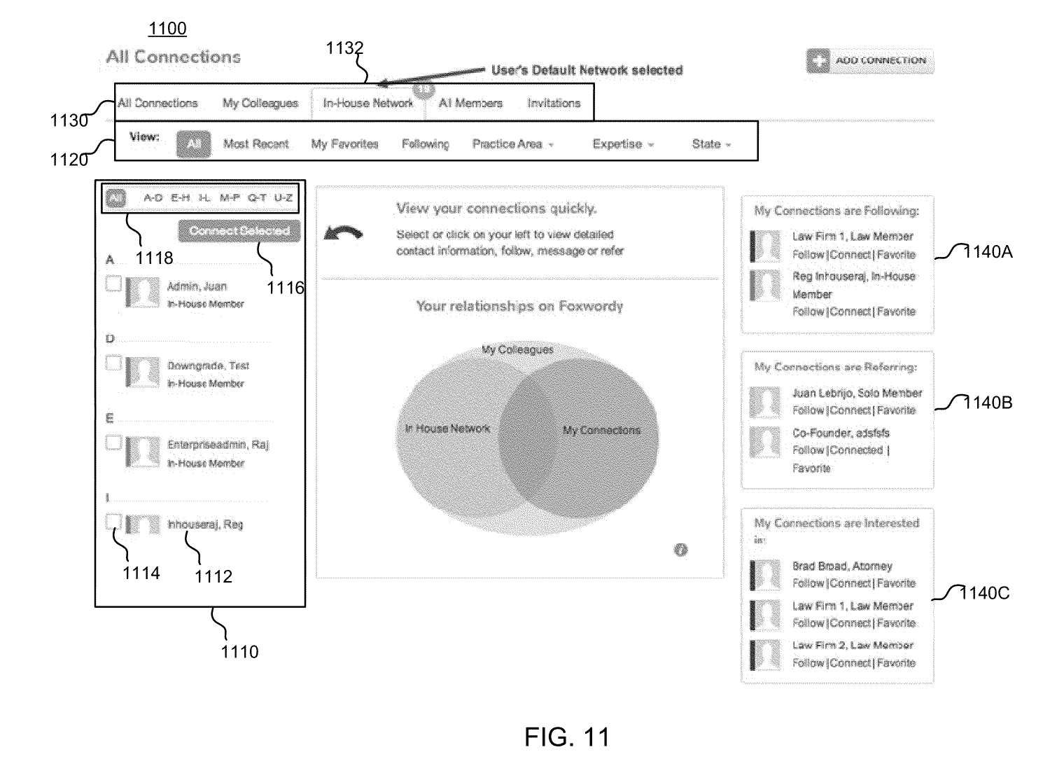

Referring to FIG. 11, illustrated is an example user interface to view filtered users in one embodiment of the disclosed configuration. The user directory interface 1100 includes a user listing 1110, which contains a user identifier 1112, a user select button, a connect selected button 1116, and an alphabetical filter 1118. The user directory interface 1110 further includes a selectable filters panel 1120 and a network selection panel 1130, which contains a default network tab 1132. Also included are socially suggested connections boxes 1140, including a followed connections box 1140A, a referred connections box 1140B, and an interesting connections box 1140C.

User profiles that are displayed in the user directory interface 1100 are included in a user listing 1110. The user listing 1110 may list a limited number of user profiles, but more user profiles may be displayed through the use of scroll buttons (not shown) in an embodiment. User profiles in the user listing 1110 are identified by a user identifier 1112. For example, a user identifier may include user name, title, and user profile picture. If a user profile picture is unavailable, a default picture may be used. In an alternate embodiment, a user's name or title may be made anonymous for privacy. In an alternate embodiment, a combination of any of the factors in a user profile entry 400 may be listed (e.g., company or location). The user select button 1114 may be used to select one or more users. After a user has selected one or more user profiles using the corresponding user select buttons 1114, the user may select the connect selected button 1116 to initiate connection requests with the selected user profiles through the connection handling process 700. An alphabetical filter 1118 may be used to filter user profiles according to an alphabetical ordering of names (e.g., first letter of last name). For example, when “All” is selected, the user listing 1110 is populated with users without consideration for alphabetical filtering. When “E-H” is selected, for example, user profiles having a last name that begins with the letters E, F, G, or H are displayed.

The selectable filters panel 1120 provides further filtering options to restrict which user profiles may appear in the user listing 1110. The selectable filters panel 1120, along with the alphabetical filter 1118, provides characteristics used to determine 930 a collection of user profiles in the user filtering process 900. Example filters include “My Favorites,” which removes from the user listing 1110 those user profiles that have not been marked as favorites by the viewing user. Another example filter is “Following,” which removes from the user listing 1110 those user profiles that have not been selected for following by the viewing users. The example filters “Practice Area” and “Expertise” prompt a user to select a practice area or expertise from a corresponding drop-down menu and remove from the user listing 1110 those users profiles that do not have the selected practice area or expertise, as stated in the corresponding user profile entries 400. Similarly, the example “State” filter prompts a user to select a state from a drop-down menu and remove from the user listing 1110 those user profiles with a location, as stated in the corresponding user profile entries 400, is not contained in the selected state. In an alternate embodiment, multiple filters from the selectable filters panel 1120 may be used to remove user profiles from the user listing 1110. In an alternate embodiment, text input may be selected from the user in place of a drop-down menu in a filter. Another example filter is “Most Recent,” which removes from the user listing 1110 those user profiles with whom a user has not recently connected. In an alternate embodiment, the “Most Recent” filter removes from the user listing 1110 those user profiles with whom a user has not recently interacted (i.e., there are not recent entries in the user interaction store 340 concerning the removed users). “Recently” or “recent” may refer to actions occurring within a time period (e.g., the last week, the last month) that is selected by a user or is preset by the default network computing system.

The network selection panel 1130 is used to select which user profiles are retrieved 920 in the user filtering process 900 for inclusion in the user listing 1110. For example, the “All Connections” tab retrieves those user profiles with which a user has a connection in the connection store 310. The example “My Colleagues” tab retrieves those users having the same company field 410 as the viewing user in the corresponding user profile entries 400. The example “All Members” tab retrieves user profiles in the default network computing system. In an alternate embodiment, the “All Members” tab retrieves those user profiles in the default network having the same account type field 414 as the viewing user in the corresponding user profile entry 400. The example “Invitations” tab retrieves those user profiles from whom the viewing user has received a request to connect. The “In-House Network” tab is an example of a default network tab 1132. The default network tab 1132 retrieves user profiles for display that have been placed by the default network creation process 800 in the same default network as the viewing user's user profile. The example “In-House Network” tab retrieves user profiles indicating the users' practice area is “In-House” for display in the user listing 1100. In an alternate embodiment, the default network tab may be differently named to reflect the attributes on which the corresponding default network is based.

The user directory interface 1100 may contain one or more socially suggested connections boxes 1140, which may display to a viewing user one or more user profiles with whom the viewing user's connections have interacted. Example socially suggested connections boxes 1140 include the followed connections box 1140A, the referred connections box 1140B, and the interesting connections box 1140C. The followed connections box 1140A displays user profiles that the viewing user's connections are following. The referred connections box 1140B displays user profiles that the viewing user's connections have referred. The interesting connections box 1140C displays user profiles in which the viewing user's connections have stated an interest. If a user profile is displayed in a suggested connections box, in one embodiment, the viewing user is presented the option to follow the user profile, connect with the user profile, or declare the user profile as a favorite. If the displayed user is already connected to the viewing user, then the displayed user may be listed as “connected” instead of suggested as a recipient of a connection request. The one or more user profiles displayed in a suggested connections box may be chosen at random from user profiles that have interacted with the viewing user's connections, or the displayed user profiles may be chosen from the user profiles that have received the most interactions from the viewing user's connections. For example, the user profiles displayed in the referred connections box 1140B may be the user profiles that have been most referred by the viewing user's connections.

### Additional Considerations

The disclosed embodiments beneficially allow for more efficient display of user profiles in a default network computing system. The use of attributes to automatically sort user profiles in the default network computing system into a default network of user profiles having similar attributes to the viewing user increases the relevance of user profiles displayed for connection. Due to the use of automatically chosen attributes, a viewing user is presented with relevant options without having to manually determine attributes or characteristics to select to attain the desired categories of users. The ability to manually filter user profiles in a directory enables a viewing user to browse user profiles that have desired attributes or characteristics. Additionally, the default networks created are constantly changing and updating in response to the changes in user profile information or addition of new user profiles.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1, 2, and 3. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 102, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating a default network based on user attributes through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for creating from one or more user profiles a collection of user profiles having one or more attributes in common, the method comprising:
selecting, from a plurality of user profiles in a default network computing system, a user profile unassociated with a particular collection of user profiles, each user profile comprising at least one attribute provided by a user of the default network computing system;
retrieving, from the default network computing system, one or more attributes from the selected user profile;
identifying, through the default network computing system, a collection of user profiles, each user profile in the collection having attributes comprising the one or more retrieved attributes of the selected user profile;
adding, through the default network computing system, the chosen user profile to the identified collection of user profiles; and
providing for display, through the default network computing system, one or more user profiles from the identified collection, the identified collection including the selected user.

2. The computer-implemented method of claim 1, further comprising:
selecting a group of one or more user profiles from the identified collection of user profiles; and
providing for display to a user of the default network computing system a recommendation to establish a connection with one or more user profiles in the selected group.

3. The computer-implemented method of claim 1, wherein the one or more attributes retrieved from the selected user profile are selected by a user of the default network computing system.

4. The computer-implemented method of claim 1, wherein the attributes retrieved from the selected user profile are selected from a group consisting of user account type, user location, user practice area, user expertise, user occupation, user industry, user sub-industry, user employer, and any combination thereof.

5. The computer-implemented method of claim 1, further comprising:
receiving an input from a particular user of the default network computing system, the particular user having a user profile and the input comprising one or more characteristics included in user profiles on the default network computing system;
determining, through the default network computing system, a collection of user profiles to which the user profile of the particular user belongs, each user in the determined collection of user profiles having a set of one or more common attributes;
selecting, through the default network computing system, from the determined collection of user profiles, one or more user profiles having the same one or more characteristics received from the particular user; and
providing for display, to the particular user of the default network computing system, the selected one or more user profiles.

6. The computer-implemented method of claim 5, wherein the one or more characteristics included in user profiles on the default network computing system are selected from a group consisting of location, practice area, expertise, occupation, name, time elapsed since last interaction with the particular user, time elapsed since establishing a connection with the particular user, number of mutual connections with the particular user, and any combination thereof.

7. A computer-implemented method for creating from one or more user profiles a collection of user profiles having one or more attributes in common, the method comprising:
selecting, from a plurality of user profiles in a default network computing system, a user profile comprising at least one attribute provided by a user;
retrieving one or more attributes from the selected user profile;
identifying a collection of user profiles, each user profile in the collection having attributes comprising the one or more retrieved attributes of the chosen user;
adding the chosen user profile to the identified collection of user profiles; and
providing for display one or more user profiles from the identified collection, the identified collection including the selected user.

8. The computer-implemented method of claim 7, further comprising:
selecting a group of one or more user profiles from the identified collection of user profiles; and
providing for display a recommendation to establish a connection with one or more user profiles in the selected group.

9. The computer-implemented method of claim 7, wherein the one or more attributes retrieved from the selected user profile are selected by a user.

10. The computer-implemented method of claim 7, wherein the attributes retrieved from the selected user profile are selected from a group consisting of user account type, user location, user practice area, user expertise, user occupation, user industry, user sub-industry, user employer, and any combination thereof.

11. The computer-implemented method of claim 7, further comprising:
receiving an input from a particular user, the particular user having a user profile and the input comprising one or more characteristics included in user profiles on the default network computing system;
determining a collection of user profiles to which the user profile of the particular user belongs, each user in the determined collection of user profiles having a set of one or more common attributes;
selecting from the determined collection of user profiles, one or more user profiles having the same one or more characteristics received from the particular user; and
providing for display, to the particular user, the selected one or more user profiles.

12. The computer-implemented method of claim 11, wherein the one or more characteristics included in user profiles are selected from a group consisting of location, practice area, expertise, occupation, name, time elapsed since last interaction with the particular user, time elapsed since establishing a connection with the particular user, number of mutual connections with the particular user, and any combination thereof.

13. A computer-readable medium configured to store instructions, the instructions when executed by a processor cause the processor to:
select, from a plurality of user profiles in a default network computing system, a user profile comprising at least one attribute provided by a user;
retrieve one or more attributes from the selected user profile;
identify, a collection of user profiles, each user profile in the collection having attributes comprising the one or more retrieved attributes of the chosen user;
add the chosen user profile to the identified collection of user profiles; and
provide for display one or more user profiles from the identified collection, the identified collection including the selected user.

14. The computer-readable medium of claim 13, further comprising instructions that cause the processor to:
select a group of one or more user profiles from the identified collection of user profiles; and
provide for display a recommendation to establish a connection with one or more user profiles in the selected group.

15. The computer-readable medium of claim 13, wherein the one or more attributes retrieved from the selected user profile are selected by a user.

16. The computer-readable medium of claim 13, wherein the attributes retrieved from the selected user profile are selected from a group consisting of user account type, user location, user practice area, user expertise, user occupation, user industry, user sub-industry, user employer, and any combination thereof.

17. The computer-readable medium of claim 13, further comprising instructions that cause the processor to:
receive an input from a particular user, the particular user having a user profile and the input comprising one or more characteristics included in user profiles on the default network computing system;
determine a collection of user profiles to which the user profile of the particular user belongs, each user in the determined collection of user profiles having a set of one or more common attributes;
select from the determined collection of user profiles, one or more user profiles having the same one or more characteristics received from the particular user; and
provide for display, to the particular user, the selected one or more user profiles.

18. The computer-readable medium of claim 17, wherein the one or more characteristics included in user profiles are selected from a group consisting of location, practice area, expertise, occupation, name, time elapsed since last interaction with the particular user, time elapsed since establishing a connection with the particular user, number of mutual connections with the particular user, and any combination thereof.
